(19) United States
(12) Patent Application Publication
(10) Pub. No.: US 2007/0141887 A1
(43) Pub. Date: Jun. 21, 2007

(54) Waterproof power connector

(75) Inventors: Chia-Chun Kuo, Tainan City (TW); Ying-Chiang Hu, Taoyuan (TW); Yii-Tay Chiou, Kaohsiung City (TW); Wen-Ying Chang, Taoyuan (TW)

Correspondence Address: BIRCH STEWART KOLASCH & BIRCH, PO BOX 747, FALLS CHURCH, VA, 22040-0747, US

(73) Assignee: Industrial Technology Research Institute, Hsin-Chu (TW)

(21) Appl. No.: 11/370,988

(22) Filed: Mar. 9, 2006

(30) Foreign Application Priority Data
Dec. 19, 2005 (TW) 94145110

(51) Int. Cl. H01R 13/52

(52) U.S. Cl. 439/281

(57) ABSTRACT

A waterproof electrical power connector is provided. The male member of the connector includes magnetic core surrounded with a winding, and the female member of the connector includes a winding and has a hollow for receiving the male member. As the male member is inserted into the female member and a current passes through the male member winding, the induced magnetic flux is coupled to the female member winding, which accordingly induces current in the female member.

### BACKGROUND OF THE INVENTION

1. Field of the Invention

The present invention relates to a waterproof electrical power connector, and more particularly to a non-contact waterproof electrical power connector by electromagnetic induction.

2. Description of the Prior Art

An electrical power connector is a device for transmitting electric energy. Conventional plug and receptacle are generally employed to connect electrical power from a power plant to home use electrical appliance. In case that an electrical appliance needs specific electrical requirements, such as specific voltages, different from what supplied by the power plant, additional proprietary adapter or transformer may be needed to transform original power signal for respective appliance to work. Conventional electrical power connectors require substantial contact or touch between wires or conductors. To a certain extent, it is usually inconvenient, or even difficult, depending on the design, to connect and disconnect conventional plug and receptacle. Accidents, such as electric shocks or even fires, can happen due to a bad connector design, an improper usage, or even simply occasional incautiousness.

Moreover, there may be a waterproof requirement for an electrical power connector used in a moisture environment. It must have, for example, waterproof mechanism to prevent from electricity leakage in receptacles for use in a bathroom or outdoors. Communication apparatuses or stations located outside need stricter waterproof requirements in the power connecting mechanism. The design of waterproof mechanism for conventional style connectors is usually complicated and inconvenient to use. As long as the substantial contact between wires and metal conductors are there, it is difficult to be satisfied in both convenience and safety.

Electromagnetic inductive coupling type connectors may be used to achieve waterproof and safety electrical power connecting. FIG. 1A and FIG. 1B illustrate two such non-contact power connectors. The two U-shape magnetic cores shown in FIG. 1A are both surrounded with electrically conductive windings. When the primary winding is connected to a power source, there will be magnetic fluxes induced in the center of the winding. For the connector shown in FIG. LA to transmit electrical power, the two U-shape magnetic cores come close to each other, so as to couple the magnetic fluxes from the primary core to the secondary core such that electrical current can be induced in the secondary winding. FIG. 1B is similar to FIG. 1A except that the magnetic core is now in cylindrical shape.

For the above electromagnetic induction connectors to work efficiently, i.e., to maintain the electrical power transmission efficiency, the alignment between the primary and the secondary magnetic cores is important. It must be as accurate as possible when both cores come close to each other. Magnetic fluxes leakage due to misalignment of magnetic cores will degrade the magnetic induction efficiency, and thus the power connecting efficiency. Furthermore, if there is no proper protecting mechanism outside the magnetic cores and windings, water and safety issues are always inevitable to happen. The U.S. Pat. No. 4,038,625, entitled as “Magnetic Inductively-coupled Connector”, provided an inductive connector with its plug and receptacle parts mounted within a pair of mating housing to clamp the two assemblies together in alignment. Considering adverse environment and mechanical abuse to which the inductive connector may be subjected, it applied a protective coating to exposed areas of the connector. U.S. Pat. No. 6,445,270, entitled as “Electromagnetic Induction Connector”, is another example which improved the shape of the magnetic cores to make sure the abutment accuracy thereof and achieved a high efficiency electrical power transmission. In view of above description, it can be noted that the accuracy of the alignment between both parts of a typical inductive connector is a key factor to the power transmission efficiency. On the other hand, there is always a need for an electrical power connector to be waterproof, free from electricity leakage, simple in structure for friendly usage.

### SUMMARY OF THE INVENTION

In view of the foregoing, it is an object of the present invention to provide an inductive electrical power connector, which achieves a high efficiency non-contact electromagnetic energy transmission by a contemplated configuration about relative location of essential elements in an electromagnetic induction pair. Such a configuration is formed naturally when the male member and female member of a connector are engaged in a manner disclosed herein.

It is another object of the present invention to provide a waterproof electrical power connector, which isolates internal electric conductors and magnetic cores from outside moisture or water with a specific housing material.

It is a further object of the present invention to provide a safety electrical power connector, which isolates internal electric conductors from human body contact with an insulating material.

It is yet another object of the present invention to provide an electrical power connector whose male member and female member are readily engaged and disengaged.

All above objects are all achieved by taking advantage of the electromagnetic induction non-contact property which enables energy transmission without substantial contact between wires and mental conductors.

According to above objects, the present invention provides a waterproof electrical power connector. A male member thereof includes a plug portion enveloping an electric conductive winding and a magnetic core surrounded therewith. A female member thereof includes a base portion with a recessed hollow. The base portion of the female member also envelops an electric conductive winding. When the male plug portion is inserted into the female hollow and an electric current flows through the primary winding the induced magnetic fluxes will be substantially conducted through the male magnetic core, which in turn induces an electric current in the secondary winding.

### BRIEF DESCRIPTION OF THE DRAWINGS

FIG. 1A and FIG. 1B show diagrams of two conventional non-contact electromagnetic inductive electrical power connectors.

FIG. 2 shows the diagram of a waterproof electrical power connector according to one embodiment of the present invention.

FIG. 3 shows a schematic diagram which illustrates the operation of a non-contact electrical power connector.

FIG. 4 shows a perspective view of the effective engaged male member and the female member according to the present invention.

FIG. 5 is a cross-sectional view of FIG. 4 at line 5-5.

FIG. 6A to FIG. 6C shows examples of mounting/dismounting mechanisms according to the present invention.

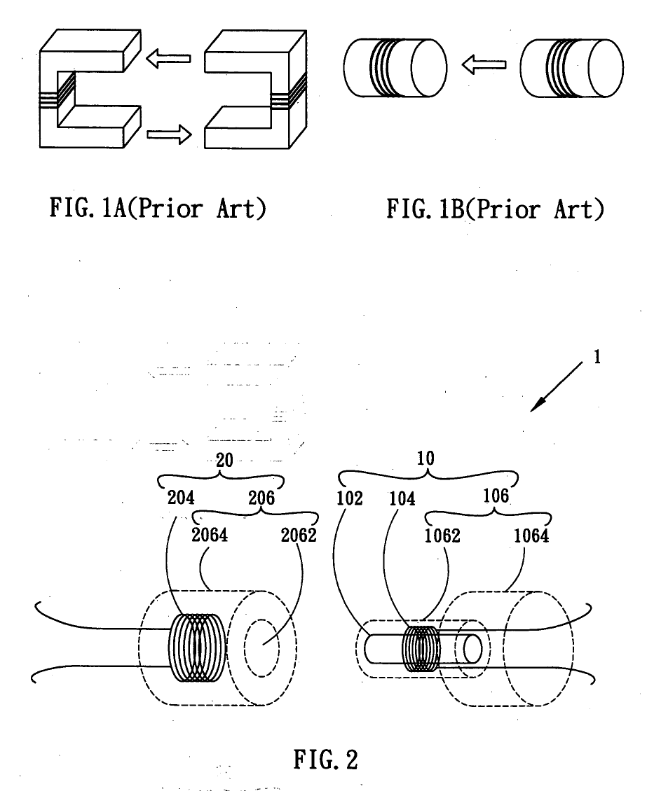

### DETAILED DESCRIPTION OF THE INVENTION

FIG. 2 shows an electrical power connector 1 according to one embodiment of the present invention. The electrical power connector 1 includes a male member 10 and a female member 20 (also traditionally known as the plug and the receptacle respectively). As shown by the dotted lines in FIG. 2, the male member 10 includes a base portion 1064 and a plug portion 1062 which coupled together to form a male member housing 106; the female member 20 includes a housing 206 containing a base portion 2064 with a hollow 2062. In this embodiment, the base portion 1064 and the plug portion 1062 are coaxial cylinders in the exterior shape, where the plug portion 1062 has a smaller diameter than that of the base portion 1064. The female base portion 2064 and the hollow 2062 therein are also in cylinder shape. The diameter of the hollow 2062 is about the same as that of the plug portion 1062 of the male member 10. The exterior appearances of the male and female members of the present invention, however, are not necessarily in cylinder shape. Moreover, the cross-section of the plug portion 1062 is not necessarily different in size or shape from that of the base portion 1064. They can, for example, have the same shape in cross-section to form a single male member. Aforementioned plug portion 1062, base portions 1064 and 2064 are made of insulated materials, such as rubber, to isolate what is inside from outside water and conductors of electricity. The materials of the plug portion 1062 and base portion 1064, however, must be magnetically transparent for a reason that will be described below.

Male member 10 contains a magnetic core 102 (e.g. a magnetic core in cylinder or stick shape) and an electrically conductive winding (typically functioning as the primary conductive winding) 104 surrounding the magnetic core 102; both the magnetic core 102 and the primary winding 104 are enveloped by the housing 106. The female member 20 also contains an electrically conductive winding (typically functioning as the secondary conductive winding) 204 enveloped in the housing 206. Respective magnetic core and/or windings are generally formed inside respective housings by an injection molding technology or the like.

The male member base portion 1064 contains an opening or openings to pass the wires coming from the primary conductive winding 104; likewise, the female member portion 2064 also contains a similar opening or openings to pass the wires coming from the secondary conductive winding 204. When the male member 10 and the female member 20 are effectively engaged with each other, the front planes of the male and female member base portions 1064 and 2064 are generally touched with the plug portion 1062 entirely inserted into the hollow 2062. If the diameter of hollow 2062 is slightly larger than that of the plug portion 1062, then they can be engaged readily. If furthermore the plug portion 1062 is made of resilient compressible material, the diameter of hollow 2062 may be equal to or even slightly less than that of the plug portion 1062 such that the male and female members can be readily connected and disconnected without additional auxiliary mechanism.

According to the electromagnetic principle, magnetic fluxes will be induced when a current flows through the primary conductive winding 104. According to one embodiment of the present invention, when the male member plug portion 1062 is inserted into the female member hollow 2062, the magnetic core 102 will reside at the center of the secondary conductive winding 204 such that the magnetic fluxes induced from above current will induce another current in the secondary conductive winding. To maintain the magnetic induction efficiency, the male and female member housings 106 and 206 must be made of materials that do not obstruct magnetic fluxes passing. Furthermore, if it makes the windings 104 and 204 concentric with each other (where winding 104 is inside winding 204) when male and female members are effectively engaged, the electromagnetic induction efficiency will be further improved.

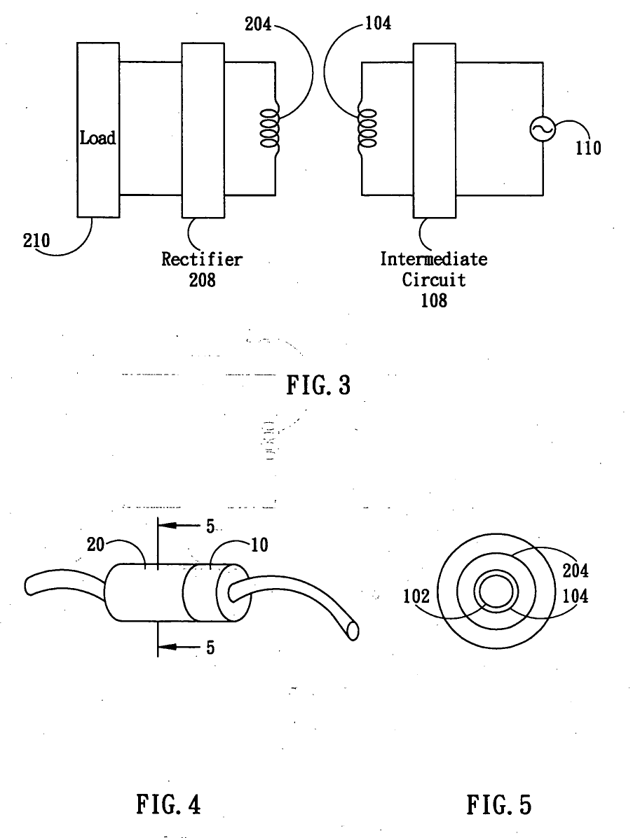

FIG. 3 shows a schematic diagram illustrating the operation of an electrical power connector according to the present invention, where only windings 104 and 204 are shown to respectively represent the male and female members. As shown in the figure, an alternating current source 110 provides an electrical power which may need to connect to an intermediate circuit 108, such as a frequency adapting circuit, before it is fed to the primary winding 104. As described above, when the male plug portion 1062 is effectively inserted into the female hollow 2062, the secondary winding 204 will induce a current. After further adapted through a rectifier 208, the resultant DC current can be applied to a load 210 (e.g. the load 210 can be a general electrical appliance or a battery recharger).

FIG. 4 shows a perspective view of an engagement between the male member 10 and the female member 20 according to one embodiment of the present invention. FIG. 5 is a cross-sectional view of FIG. 4 at the cross-sectional line 5-5. As shown in FIG. 5, when the male member 10 and the female member 20 are effectively engaged, the female secondary winding 204, the male primary winding 104 and the cross-section of the magnetic core 102 are configured into three concentric circles. When viewed from a specific orientation, it will find that the secondary winding 204 envelops the primary winding 104 which in turn envelops the magnetic core 102 such that a high efficiency electromagnetic induction configuration is achieved. When the male member 10 and the female member 20 are effectively engaged, the proper position of the magnetic core 102 ensures a tiny magnetism leakage and facilitates the electricity induction at the female secondary winding 204. It should be emphasized that the proper configuration is achieved through the contemplated design between the male and the female members as well as the relative location arranged between both windings and the magnetic core. It makes a user achieve a high efficiency power connection through a friendly design. Additionally, through proper arrangement of the ratio of the number of turns of windings 104 and 204, the amount of current induced in the secondary winding can be controlled and thus the voltage applied to load 210 can be adapted if desired. The efficiency will be close to a conventional transformer.

By properly selecting the materials, for example, in accordance with the requirements of electricity isolation and waterproof and magnetic conductivity, for the male member housing 106 and the female member housing 206, the resulting power connector according to the present invention is not only suitable for moisture environment and any other places requiring waterproof power connection devices but also favorable for general home use as a safety electrical power connector comparing to conventional ones which need substantial contact between naked wires.

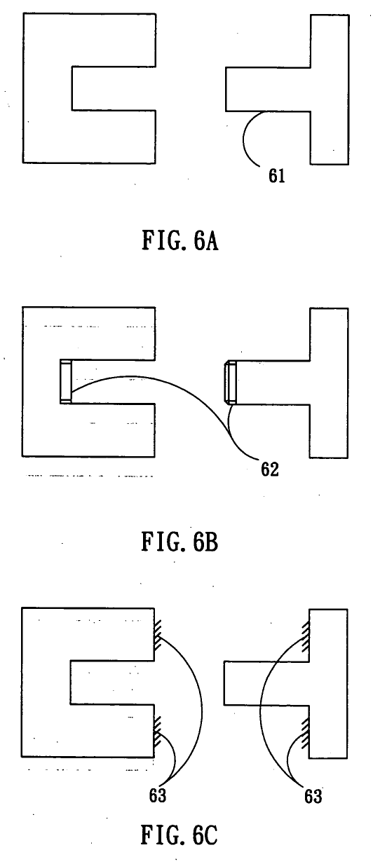

Additionally, due to the readily aligning feature between the male and female members, it is easy to accomplish a friendly mounting/dismounting mechanism for an electrical power connector according to the present invention without compromising power transmission efficiency. Referring to FIG. 6A through FIG. 6C, which collectively show three examples with friendly mounting/dismounting mechanism. Only the outlines of male and female housing are shown in FIG. 6A through FIG. 6C. All other details are omitted for simplicity purpose. The plug portion housing shown in FIG. 6A is made of resilient compressible material 61 such that even the diameter of the female hollow is equal to or slightly less than that of the male plug portion, the male member can be readily engaged and disengaged with the female member. In another example shown in FIG. 6B, the front end of the male plug portion comprises a mounting or screw structure 62 for engaging with the female member. When a male member according to FIG. 6B is inserted into a female member according to FIG. 6B in certain orientation, after rotating the male member in some direction, the two members will be engaged. Rotating the male member in a counter direction, the two members will be disengaged. In a further example as shown in FIG. 6C, the front planes of base portions of both male and female members have affixing elements 63, such as Velcro tapes, such that they can be engaged and disengaged readily. Of course, in accordance with the present invention, the affixing elements 63 can also reside on the male plug portion tip and female hollow bottom respectively.

Although only preferred embodiments have been illustrated and described, it will be appreciated by those skilled in the art that various modifications may be made without departing from the scope of the present invention. Possible such modifications include, but are not limited to, housing materials, housing shapes, engaging styles, and number of winding turns, which is intended to be limited solely by the appended claims.

What is claimed is:

1. A waterproof electrical power connector comprising:
a male member comprising a plug portion, said plug portion enveloping both a magnetic core and a primary conductive winding surrounding said magnetic core; and
a female member comprising a female base portion, said female base portion having a hollow to accommodate said plug portion and enveloping a secondary conductive winding;
when said plug portion is inserted into said hollow and a current flows through said primary conductive winding, induced magnetic fluxes will be mainly conducted by said magnetic core and will induce another current in said secondary conductive winding.

2. The waterproof electrical power connector according to claim 1, further comprising a male base portion coupled with said plug portion.

3. The waterproof electrical power connector according to claim 1, wherein said plug portion is in cylindrical shape and said hollow is also in cylindrical shape with a diameter about equal to that of said plug portion.

4. The waterproof electrical power connector according to claim 1, wherein said plug portion and said female base portion are made of waterproof and electrically insulated materials.

5. The waterproof electrical power connector according to claim 1, wherein said plug portion and said female base portion are made of materials not obstructing magnetism.

6. The waterproof electrical power connector according to claim 2, wherein said male base portion, said male member plug portion, and said female base portion are formed by injection molding technology

7. The waterproof electrical power connector according to claim 1, wherein sizes of both said plug portion and said hollow are designed such that said primary conductive winding and said secondary conductive winding are generally concentric with each other when said plug portion is entirely inserted into said hollow.

8. The waterproof electrical power connector according to claim 1, further comprising a frequency adapter connecting to said primary conductive winding to change the frequency of said current.

9. The waterproof electrical power connector according to claim 1, further comprising a rectifier connecting to said secondary conductive winding to rectify said another current to a direct current.

10. The waterproof electrical power connector according to claim 1, further comprising screw structure around the tip end of said plug portion and bottom in said hollow of said female base portion such that when said plug portion is inserted into said hollow in certain orientation and then rotates said male member in some direction, said male and female members will be engaged, rotating said male member in a counter direction, said male and female members will be disengaged.

11. The waterproof electrical power connector according to claim 2, further comprising affixing elements on the front plane of said male base portion and said female base portion such that said male member and female member can be readily engaged and disengaged.

12. The waterproof electrical power connector according to claim 1, further comprising affixing elements on the tip end of said plug portion and on the bottom of said female hollow such that said male member and female member can be readily engaged and disengaged.

13. A waterproof male electrical power connector member comprising:
a plug portion enveloping a magnetic core and a primary conductive winding surrounding said magnetic core;
when said plug portion is inserted into a hollow in a female connector member and a current flows through said primary conductive winding, induced magnetic fluxes will be mainly conducted by said magnetic core and will induce another current in a secondary conductive winding in said female connector member.

14. The waterproof male electrical power connector member according to claim 13, further comprising a male base portion coupled with said plug portion.

15. The waterproof male electrical power connector member according to claim 13, wherein said plug portion is made of waterproof and electrically insulated materials.

16. The waterproof male electrical power connector member according to claim 13, wherein said plug portion is made of materials not obstructing magnetism.

17. The waterproof male electrical power connector member according to claim 13, wherein a size of said plug portion is designed such that said primary conductive winding and said secondary conductive winding are generally concentric with each other when said plug portion is entirely inserted into said hollow.

18. The waterproof male electrical power connector according to claim 14, further comprising affixing elements on the front plane of said male base portion or on the tip end of said plug portion such that said male member and female member can be readily engaged and disengaged.

19. A waterproof female electrical power connector member comprising:
a female base portion having a hollow; and
a secondary conductive winding enveloped by said female base portion;
when a male plug portion is inserted into said hollow and a current flows through a primary conductive winding in said male plug portion, induced magnetic fluxes will be mainly conducted by a magnetic core surrounded by said primary conductive winding and will induce another current in said secondary conductive winding.

20. The waterproof female electrical power connector member according to claim 19, wherein said female base portion is made of waterproof and electrically insulated materials.

21. The waterproof female electrical power connector member according to claim 19, wherein said female base portion is made of materials not obstructing magnetism.

22. The waterproof female electrical power connector member according to claim 19, wherein a size of said female hollow is designed such that said primary conductive winding and said secondary conductive winding are generally concentric with each other when said male plug portion is entirely inserted into said female hollow.

23. The waterproof female electrical power connector member according to claim 19, further comprising affixing elements on the front plane of said female base portion or on the bottom of said female hollow such that said male member and female member can be readily engaged and disengaged.
